(19) United States
(12) Patent Application Publication
(10) Pub. No.: US 2014/0217804 A1
(43) Pub. Date: Aug. 7, 2014

(54) SEAT BELT DEVICE

(71) Applicant: AUTOLIV DEVELOPMENT AB, Vargarda (SE)

(72) Inventors: Eiji Maemura, Yokohama (JP); Tatsuya Harada, Yokohama (JP)

(73) Assignee: AUTOLIV DEVELOPMENT AB, Vargarda (SE)

(21) Appl. No.: 14/168,188

(22) Filed: Jan. 30, 2014

(30) Foreign Application Priority Data
Feb. 1, 2013 (JP) 2013-018801

(51) Int. Cl. B60R 22/12; B60R 22/34

(52) U.S. Cl. CPC B60R 22/12; B60R 22/34
USPC 297/474

(57) ABSTRACT

A seatbelt device for a vehicle. The seatbelt device includes a seatbelt connected at a first end to retractor and connected at a second end to a belt position changing member, which is movable between forward and rearward positions relative to the vehicle. The second end of the seatbelt is connected to the belt position changing member such that the position of the second end of the seatbelt changes relative to the belt position changing member, as the belt position changing member is moved from the rearward position to the forward position, thereby preventing the webbing of the seatbelt from twisting and inverting of the tongue plate upon activation of the belt position changing member, the latter which makes the tongue the plate difficult for an occupant to reach.

### BACKGROUND

1. Field of the Invention

The present invention relates to a seat belt device for restraining and protecting an occupant of a vehicle.

2. Description of the Related Art

A three-point seat belt for restraining and protecting an occupant in a vehicle at the time of its crash includes a webbing that restrains the occupant. The webbing is stretched in a vertical direction in a vehicle interior by having one of its ends wound around a retractor and the other end fixed to a lower part of the vehicle cabin.

The webbing is inserted through a through anchor located at an upper part of the vehicle cabin, folded downward, and wound around the retractor. The retractor prevents the webbing from being loosened, by winding the webbing therearound. The retractor, therefore, is configured to constantly add tension to the webbing.

When fastening the seat belt, the occupant grabs a tongue plate located between the through anchor and an anchor plate and pulls out the webbing against the force of the retractor, which is trying to wind up the webbing. The tongue plate is consequently moved by the occupant to the opposite side of the seat of the occupant (to the center of the vehicle) and attached to a buckle. As a result, the body of the occupant is restrained by the webbing fixed at the three points of the occupant: the shoulder and either side of the hip.

However, because the other end of the webbing is fixed to the anchor plate that is fixed to the lower part of the vehicle cabin (on the floor), the occupant seated in the seat needs to twist his/her upper body to grab the tongue plate located behind the seat back, which makes it difficult to fasten the seat belt device.

Japanese Patent Application Publication No. 2008-126880 discloses a seat belt device that is provided with a reacher in place of an anchor plate in order to move a webbing to a favorable position. This reacher includes a hard, boot-like cover located between a seat and a door, a rotation mechanism, and biasing means.

The reacher accommodates the webbing of a predetermined length from the other end thereof fixed to a lower part of the vehicle cabin. The rotation mechanism supports the reacher rotatably in such a manner that the reacher tilts in a vehicle longitudinal direction with respect to a base end portion of the reacher. The biasing means applies biasing force to the reacher so that the reacher tilts forward in the vehicle longitudinal direction. Note that the biasing means is usually in the form of a spring that is installed in the rotation mechanism and constantly adds the biasing force to the reacher.

According to the seat belt device disclosed in Japanese Patent Application Publication No. 2008-126880, the reacher accommodating a part of the webbing is tilted backward by force of a retractor winding up the webbing, and tilted forward as well by the force of the biasing means. The force of the retractor in winding up the webbing may be weakened in order to cause the reacher to function. This makes the force of biasing means relatively greater whereby the reacher is tilted forward, the webbing is stretched out forward, and moreover a tongue plate mounted to the webbing moves to a place where the occupant can more easily grab the tongue plate.

### SUMMARY

However, when the reacher tilts forward and the webbing is pushed forward, the webbing happens to be twisted at a leading end portion of the reacher, making the posture of the tongue plate unstable, i.e., inverting the tongue plate. The twisted webbing at the leading end portion of the reacher also spoils the appearance of the seat belt device.

The inverted tongue plate forces the occupant to turn the tongue plate over in order to attach the tongue plate to the buckle, despite the fact that the webbing is brought by the reacher to the position that allows the occupant to easily pull out the webbing. Such design of the seat belt device undermines the convenience of the reacher.

The present invention was contrived in view of such circumstances, and an object thereof is to provide a seat belt device that is capable of preventing a webbing from being twisted upon activation of a reacher.

In order to accomplish the object, a configuration of the seat belt device according to one embodiment of the present invention has a retractor that winds up one end of a webbing extending generally in a vertical direction of a vehicle cabin and thereby adds tension to the webbing, and has a long reacher that has a base end portion supported rotatably on a lower part of the vehicle cabin and that is tilted in a vehicle longitudinal direction with respect to the vicinity of the base end portion, wherein the reacher has, at a leading end portion thereof, a rotation supporter that rotatably holds the other end of the webbing in the vehicle longitudinal direction with respect to the reacher.

In a case where the reacher tilts forward and the webbing is pushed forward, the webbing is positioned behind the reacher. In this state of the configuration, the other end of the webbing is not simply folded at the leading end portion of the reacher but is rotated to the back of the vehicle with respect to the rotation supporter provided at the leading end portion of the reacher. Owing to such a configuration in which the webbing can be rotated in the vehicle longitudinal direction with respect to the reacher, the webbing can be prevented from being twisted by the reacher.

Preventing the webbing from being twisted in this manner provides a favorable appearance of the seat belt device and stabilizes the posture of the tongue plate mounted to the webbing. In a case where the posture of the tongue plate becomes unstable or inverted, the occupant needs to turn the tongue plate over, grabs the tongue plate, and then attaches the tongue plate to the buckle. The configuration described above, however, can stabilize the posture of the tongue plate, making it easy for the occupant to wear the webbing.

It is preferred that the rotation supporter have an insertion hole into which the other end of the webbing is inserted. In such a simple configuration in which the insertion hole for inserting the other end of the webbing therethrough is formed directly at the leading end portion of the reacher, the webbing can be rotated in the vehicle longitudinal direction in such a manner as to follow the tilting motion of the reacher in the vehicle longitudinal direction. Consequently, the webbing can be prevented from being twisted by the reacher.

It is preferred that the rotation supporter have a rotating shaft provided at the leading end portion of the reacher, a rotating member that rotates in the vehicle longitudinal direction about the rotating shaft, and an insertion hole that is formed in the rotating member and into which the other end of the webbing is inserted. In such a configuration, the rotating member rotates in the vehicle longitudinal direction about the rotating shaft in such a manner as to follow the tilting motion of the reacher in the vehicle longitudinal direction. Consequently, the webbing can be prevented from being twisted by the reacher.

It is preferred that the insertion hole be thin and long in a width direction of the webbing. The other end of the webbing is inserted through this thin, long insertion hole of the rotating member. This can rotate the webbing in the vehicle longitudinal direction as the rotating member rotates, without being shifted with respect to the insertion hole. Therefore, the webbing can reliably be prevented from being twisted by the reacher.

It is preferred that the rotation supporter have a plate provided at the leading end portion of the reacher, and an insertion hole that is formed in the plate and into which the other end of the webbing is inserted. Such a configuration can allow the webbing to rotate in the insertion hole of the plate in the vehicle longitudinal direction in such a manner as to follow the tilting motion of the reacher in the vehicle longitudinal direction. Consequently, the webbing can be prevented from being twisted by the reacher.

It is preferred that the insertion hole include an arc portion to allow the other end of the webbing to slide in contact therewith. The other end of the webbing is inserted into the insertion hole having the arc portion. In this configuration, the webbing can be rotated reliably in the vehicle longitudinal direction while sliding along the arc portion of the insertion hole in such a manner as to follow the tilting motion of the reacher in the vehicle longitudinal direction. Consequently, the webbing can be prevented from being twisted by the reacher.

It is preferred that the other end of the webbing that is inserted into the insertion hole be folded to sandwich the insertion hole. In this configuration, the folded part of the other end of the webbing that has the insertion hole therebetween and the vicinity of the other end of the webbing that faces this folded part can be, for example, sewn together, whereby the other end of the webbing can be supported by the rotation supporter having the insertion hole.

It is preferred that the space between the base end portion of the reacher and the rotation supporter be covered with a boot-like cover. Such a configuration can keep the shape of the space between the base end portion of the reacher and the rotation supporter, making, for example, the shape of the reacher flat and long.

It is preferred that the base end portion of the reacher and the rotation supporter be coupled to each other by a belt similar to the webbing. According to this configuration, when the webbing is pulled into the vehicle as the occupant fastens the seat belt device, the belt bends inward of the vehicle. This allows the rotation supporter to be moved toward the inside of the vehicle in such a manner as to follow the motion of the webbing.

It is preferred that the space between the base end portion of the reacher and the rotation supporter be configured by a metal or resin plate. In this case, a base end portion and leading end portion of the plate may be shaped to have the same functions as the base end portion of the reacher and the rotation supporter, thereby simplifying the configuration of the seat belt device. When the webbing is pulled into the vehicle as the occupant fastens the seat belt device, the plate bends inward of the vehicle. This allows the rotation supporter to be moved toward the inside of the vehicle in such a manner as to follow the motion of the webbing.

It is preferred that the base end portion of the reacher and the rotation supporter be coupled to each other by a wire. In this configuration, when the webbing is pulled into the vehicle as the occupant fastens the seat belt device, the wire reliably bends inward of the vehicle. This allows the rotation supporter to be moved toward the inside of the vehicle in such a manner as to follow the motion of the webbing.

Accordingly, by employing the principles of the present invention, a seat belt device that is capable of preventing a webbing from being twisted upon activation of a reacher can be provided.

### BRIEF DESCRIPTION OF THE DRAWINGS

FIGS. 1A and 1B are diagrams illustrating a seat belt device according to a first embodiment of the present invention;

FIG. 2 is a diagram showing the seat belt device of FIGS. 1A and 1B from one side of the vehicle;

FIG. 3 is an enlarged view showing a part of the seat belt device of the first embodiment;

FIG. 4 is a diagram illustrating a comparative example of a seat belt, in contradistinction to a seat belt embodying the principles of the present invention;

FIGS. 5A and 5B are diagrams illustrating a portion of a seat belt, similar to that seen in FIGS. 1A and 1B, according to a second embodiment of the present invention;

FIG. 6 is a diagram illustrating a third embodiment incorporating the principles of the present invention; and

FIG. 7 is a diagram illustrating a fourth embodiment incorporating the principles of the present invention.

### DETAILED DESCRIPTION

Preferred embodiments of the present invention are described hereinafter in detail with reference to the accompanying drawings. The sizes, materials and other specific numerical values illustrated in these embodiments are merely illustrative to facilitate a ready understanding of the present invention and are not intended to limit the present invention, unless otherwise noted. It should be noted that the components with substantially the same functions and configurations are denoted by the same reference numerals throughout the present specification and the drawings, and redundant description thereof will be omitted accordingly. In addition, illustration of various components of a seat belt that have no direct connection with principles the present invention are also omitted.

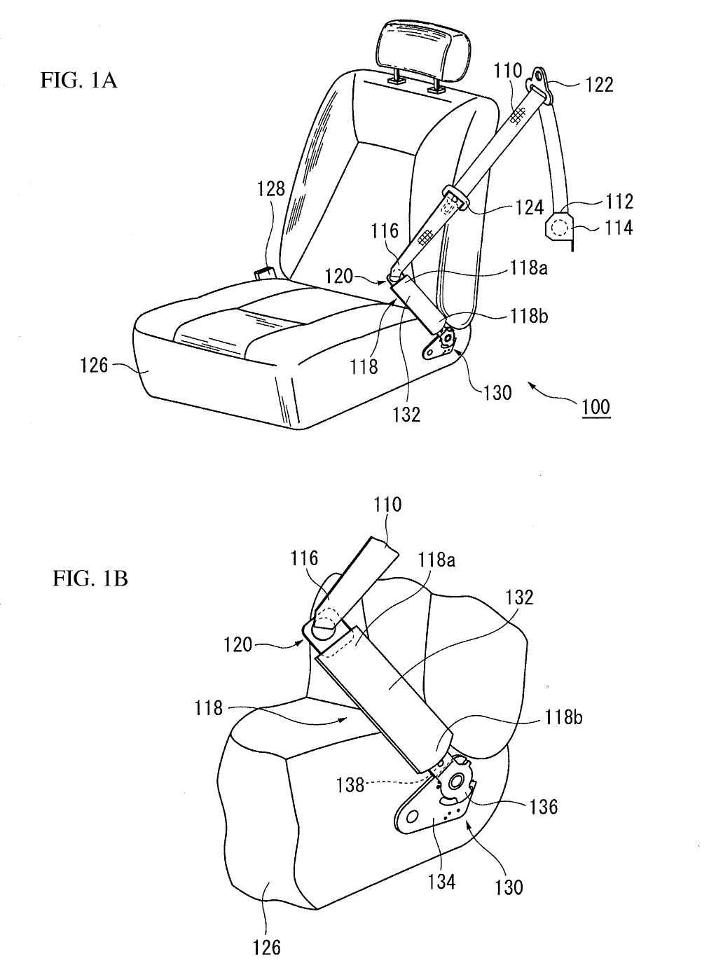

FIGS. 1A and 1B are diagrams illustrating a seat belt device according to a first embodiment and incorporating the principles of the present invention. FIG. 1A is a diagram in which the seat belt device is applied to a left front seat of the vehicle. FIG. 1B is an enlarged portion of the seat belt device seen in FIG. 1A.

The seat belt device 100 is a three-point seat belt device for restraining and protecting an occupant in a vehicle at the time of its crash and has a webbing 110 extending from an upper part of a side surface of a vehicle's cabin or passenger compartment. The webbing 110 has one end 112 thereof wound around a retractor 114 and the other end 116 held rotatably by a rotation supporter 120, which is provided at a leading end portion 118a of a reacher (a belt position changing member) 118.

The retractor 114 is mounted to a lower part of the side surface of the vehicle cabin such as an area under a center pillar, e.g. a B-pillar, which is not shown. The webbing 110 is pulled out of the retractor 114, for example, inserted into a through anchor 122 mounted to the upper part of the side surface of the vehicle cabin, such as in an upper area of the center pillar, and then folded downward.

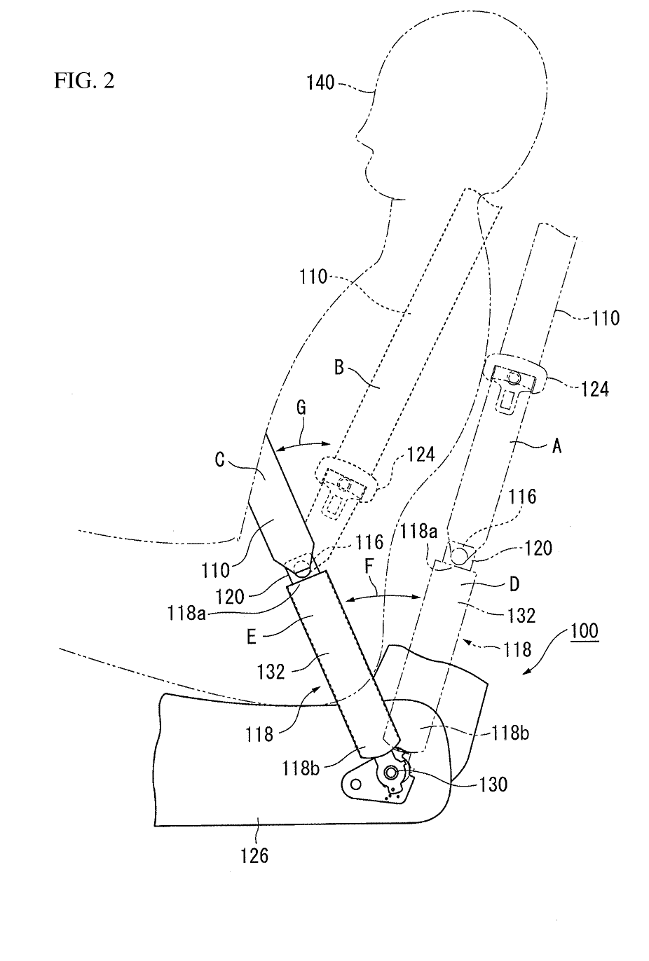

The retractor 114, around which the end 112 of the webbing 110 is wound, constantly adds tension to the webbing 110 in order to prevent the webbing 110 from being loosened. The mechanism by which the tension is applied is well known and need not be further described in detail. The end 116 of the webbing 110, apart from the retractor and after being folded at the through anchor 112, is held rotatably by the rotation supporter 120, whereby the webbing 110 is generally stretched out in a vertical direction of the vehicle cabin, which is partially shown in phantom to the right side of FIG. 2.

In addition, the webbing 110 after folding at the through anchor 122 is inserted through a tongue plate 124. Note that the tongue plate 124 is capable of sliding on the webbing 110. A buckle 128 is disposed in a place in a seat 126 toward to the center of the vehicle cabin.

In this three-point seat belt device 100, the occupant seated in the seat 126 can grab the tongue plate 124 and mount the tongue plate 124 into the buckle 128 to restrain his/her body with the webbing 110 fixed at three points: the shoulder and either side of the hip of the occupant.

As noted above, FIG. 1B is a partial enlarged view of FIG. 1A. The reacher 118 has, for example, the rotation supporter 120 provided at the leading end portion (a distal end) 118a, and a base end portion (a proximal end) 118b supported rotatably on a lower part of the vehicle cabin by a rotation mechanism 130. Note that the lower part of the vehicle cabin may indicate the area on the vehicle side or the area on the cushion side of the seat 126. However, for the purpose of stabilizing the positional relation between the occupant seated in the seat 126 and the reacher 118, it is preferred that the base end portion 118b be mounted to the cushion side, or, in other words, a lower part of a side surface of the seat 126.

The space between the base end portion 118b of the reacher 118 and the rotation supporter 120 is covered with a boot-like cover 132, as shown in the diagram. The cover 132 is, for example, a flat, long and hard member. Thus, while keeping this long shape of the cover 132, the reacher 118 can be tilted or rotated in the vehicle longitudinal direction, in other words forward relative to the vehicle, with respect to the vicinity of the base end portion 118b. Furthermore, the rotation supporter 120 rotatably holds and positions the end 116 of the webbing 110 in the vehicle longitudinal direction with respect to the reacher 118.

The reacher 118 functions to pull the webbing 110 forward when tilted forward by the rotation mechanism 130, the webbing 110 being held by the rotation supporter 120. It is therefore necessary that the cover 132 be hard. The cover 132 may be made of, for example, thermoplastic elastomer (thermo plastic olefin (TPO)) resin.

In regard to the material of the cover 132, one that is hard enough to keep the shape of the cover 132 when molding the cover 132 is preferred. Examples of such material include polyethylene and other materials that can provide an appropriate thickness to keep the shape of the cover 132. In addition to these materials, nylon, polypropylene, engineering plastic or the like can be used as the material of the cover 132 as long as it can provide the appropriate thickness to keep the shape of the cover 132.

The rotation mechanism 130 includes a base plate 134, an anchor bracket 136, and a base end portion-side anchor plate 138. The base plate 134 is fixated to the lower part of the side surface of the seat 126. The anchor bracket 136 is mounted rotatably onto the base plate 134. The base end portion-side anchor plate 138 is located in the vicinity of the base end portion 118b of the reacher 118 and coupled to the anchor bracket 136.

The rotation mechanism 130 further includes a return spring, not shown, which functions as biasing means to act on the reacher 118. The return spring functioning as the biasing means is mounted to both the base plate 134 and the anchor bracket 136 and applies a force for rotating the anchor bracket 136 counterclockwise (in the illustrated embodiment) with respect to the fixed base plate 134. Therefore, for example, the counterclockwise rotation of the anchor bracket 136 caused by the biasing means leads to application of a biasing force, via the base end portion-side anchor plate 138 coupled to the anchor bracket 136, to the reacher 118 to tilt or rotate the reacher 118 forward in the vehicle longitudinal direction.

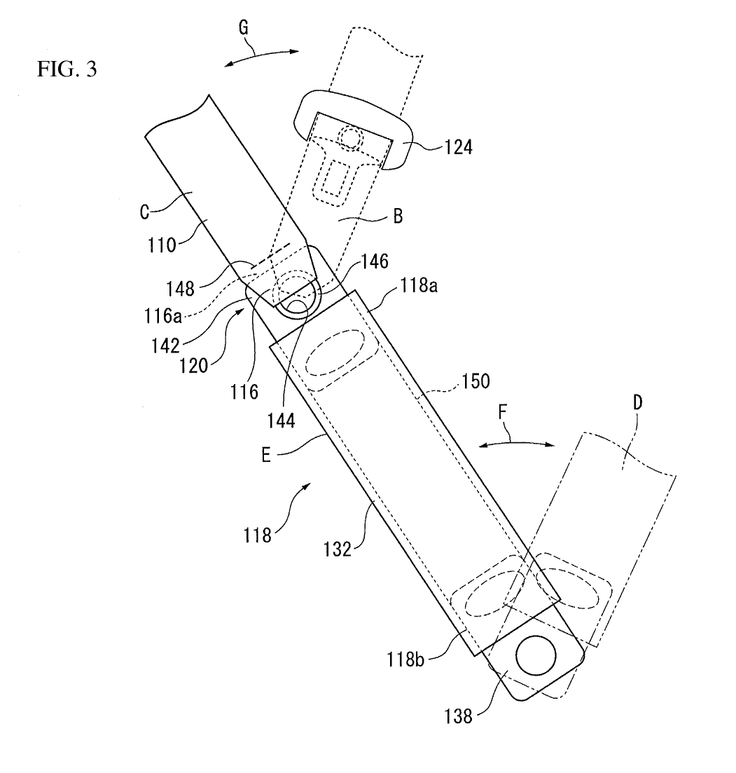

The movements of the webbing 110 associated with activation of the reacher 118 and how an occupant 140 wears the webbing 110, are described hereinafter with reference to FIGS. 2 and 3. FIG. 2 is a diagram showing the seat belt device 100 of FIG. 1A from one side of the vehicle. FIG. 3 is an enlarged view showing a part of the seat belt device 100 of FIG. 2.

The webbing 110 shown by a chain line A in FIG. 2 illustrates a state obtained prior to activation of the reacher 118, and the webbing 110 is stretched out substantially linearly in the vertical direction. The webbing 110 shown by a dotted line B illustrates a state obtained at the time of the activation of the reacher 118, and, in this position, the webbing 110 is pushed forward as compared to the state obtained prior to the activation of the reacher. In this state, however, the tongue plate 124 is not yet attached to the buckle 128. The webbing 110 shown by a solid line C illustrates a state in which the occupant 140 has attached the tongue plate 124 to the buckle 128. Note that the shoulder belt side is not shown in the webbing 110 in the solid line C.

The reacher 118 is tilted backward by the force of the retractor 114 winding up the webbing 110 and is tilted forward as well by the force of the biasing means of the rotation mechanism 130. Therefore, the position of the reacher 118 is determined by the balance between this force of the retractor winding up the webbing and the force of the biasing means. For instance, in a case where the force of the retractor winding up the webbing is relatively greater than the force of the biasing means, the reacher 118 is accommodated in a position shown by a chain line D (referred to as “accommodated position,” hereinafter).

When the force of the biasing means becomes relatively greater than the force of the retractor 114 winding up the webbing 110, the reacher 118 is tilted forward and held at a position shown by a solid line E (referred to as “active position,” hereinafter). In other words, when activated, the reacher 118 tilts forward in the vehicle longitudinal direction from the accommodated position to the active position with respect to the vicinity of the base end portion 118b, as shown by an arrow F. When using a motor retractor as the retractor 114, the force of the retractor 114 winding up the webbing 110 is reduced by rotating the rotary shaft of the motor in a direction corresponding to the direction of pulling the webbing 110.

When the reacher 118 is in the active position, the webbing 110 is pushed forward, as shown by the dotted line B, and the tongue plate 124 attached to the webbing 110 is moved downward relative to the occupant 140, to a position where the occupant 140 can more easily grab the tongue plate 124.

In a case where the reacher 118 is tilted forward and the webbing 110 is pushed forward, the webbing 110 is rotated relative to the rotation supporter 120 toward the rear of the vehicle, which is, in other words, in the vicinity of the leading end portion 118a of the reacher 118. This relative rotation is generally shown by an arrow G.

As shown in FIG. 3, the rotation supporter 120 includes a leading end portion-side plate 142 provided at the leading end portion 118a of the reacher 118. The leading end portion-side plate 142 has an insertion hole 144 into which the end 116 of the webbing 110 is inserted. A bushing 146 for reducing the friction between the insertion hole 144 and the end 116 of the webbing 110 is attached to the insertion hole 144. Therefore, the webbing 110 inserted into the insertion hole 144 can be rotated in the vehicle longitudinal direction with respect to the reacher 118 in such a manner as to follow the tilting motion of the reacher 118 in the vehicle longitudinal direction (see the arrow F).

The end 116 of the webbing 110 that is inserted into the insertion hole 144 is folded back over itself so as to sandwich part of the rotation supporter and the insertion hole 144. This folded portion 116a is sewn in the vicinity of the opposing end 116 of the webbing 110, as shown by, for example, a sewing line 148. As a result, the end 116 of the webbing 110 can be held by the rotation supporter 120, including the insertion hole 144.

When occupant 140 wears the webbing 110, the webbing 110 shown by the dotted line B is rotated to the front side of the vehicle about the vicinity of the rotation supporter 120 or, in other words, about the vicinity of the leading end portion 118a of the reacher 118, with respect to the reacher 118 (see the arrow G), to enter the state shown by the solid line C. The body of the occupant 140 is then restrained by the webbing 110 fixed at the three points: the shoulder and either side of the hip of the occupant 140.

Note that the cover 132 covers the space between the base end portion 118b of the reacher 118 and the rotation supporter 120, as described above, and accommodates the base end portion-side plate 138, which is a part of the rotation mechanism 130, and the leading end portion-side plate 142, which is a part of the rotation supporter 120, as shown in FIG. 3. A belt 150 of the same type as the occupant-restraining webbing 110, provided independently from the webbing 110, is stretched out between these plates 138 and 142.

When the occupant 140 wears the webbing 110, the leading end portion-side plate 142 is moved inward of the vehicle by pulling the webbing 110 inward of the vehicle. Because the leading end portion-side plate 142 is connected to the base end portion-side plate 138 by the belt 150 capable of bending, the leading end portion-side plate 142 can be moved inward of the vehicle in such a manner as to follow the motion of the webbing 110.

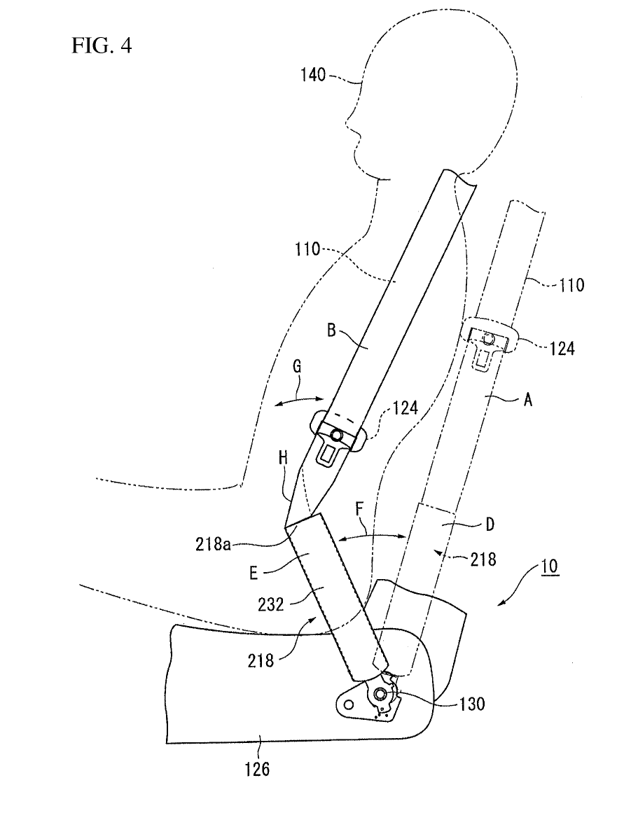

FIG. 4 is a diagram illustrating a comparative example compared with the first embodiment of the present invention illustrated in FIG. 2. A seat belt device 10 of the comparative example is different from the seat belt device 100 in that a leading end portion 218a of a reacher 218 of the seat belt device 10 is not provided with the rotation supporter 120. As with the state illustrated in FIG. 2, the state shown by a chain line A on the right-hand side of FIG. 4 illustrates the webbing 110 of the seat belt device 10 stretched out substantially linearly in the vertical direction.

In the seat belt device 10 of the comparative example, when the reacher 218 is tilted forward by being moved from the accommodated position shown by a chain line D to the active position shown by a solid line E, then the webbing 110 is pushed forward. At this moment, the seat belt device 10 is in the state shown by a solid line B on the left-hand side of FIG. 4. In this state, sometimes the webbing 110 happens to be twisted or folded over at the leading end portion 218a of the reacher 218, as shown by reference numeral H in the diagram. The webbing 110 twisted at the leading end portion 218a of the reacher 218 not only spoils the appearance of the seat belt device, but also forms wrinkles on the webbing 110. Moreover, the posture of the tongue plate 124 becomes unstable, and the webbing 110 becomes inverted due to the formation of wrinkles thereon and the twisting at H.

In a case where the tongue plate 124 is inverted, it forces the occupant 140 to turn the tongue plate 124 over in order to attach the tongue plate 124 to the buckle 128, despite the fact that the webbing 110 is brought, by the reacher 218 and the rotation mechanism 130, to a position that allows the occupant 140 to easily pull out the webbing 110. Such a design makes it difficult to attach the webbing 110 and undermines the convenience of the reacher 218.

The seat belt device 100 according to the present embodiment, on the other hand, is configured in such a manner that the webbing 110 is positioned or angled behind the reacher 118 when the reacher 118 is tilted forward and the webbing 110 is consequently pushed forward. In this state, however, the end 116 of the webbing 110 is rotated with respect to the insertion hole 144 of the rotation supporter 120 provided at the leading end portion 118a of the reacher 118. Instead of being simply folded at the leading end portion 118a of the reacher 118, the webbing 110 is rotated toward the back of the vehicle.

Therefore, the configuration of the seat belt device 100 in which the webbing 110 can be rotated in the vehicle longitudinal direction with respect to the reacher 118 can prevent the webbing 110 from being twisted upon activation of the reacher 118. Preventing the webbing 110 from being twisted by the reacher 118 provides a favorable appearance of the seat belt device, stabilize the posture of the tongue plate 124 mounted to the webbing 110, and therefore enable easy attachment of the webbing 110.

In addition, according the embodiment described above, the insertion hole 144 of the leading end portion-side plate 142 that allows the rotation of the webbing 110 is provided with the bushing 146 to reduce the friction between the insertion hole 144 and the end 116 of the webbing 110, allowing the webbing 110 to rotate more smoothly. However, the present invention is not limited to this configuration. In other words, as long as the webbing 110 can be rotated with respect to the leading end portion-side plate 142, the end 116 of the webbing 110 may directly be inserted into the insertion hole 144 without providing the bushing 146 thereto. In this manner, the configuration of the reacher 118 can be more simplified.

The embodiment is also configured to accommodate the base end portion-side plate 138 and the leading end portion-side plate 142 in the cover 132 of the reacher 118 and to couple the plates 138 and 142 using the belt 150. However, as long as the reacher 118 can bend in a width direction of the vehicle, the embodiment is not limited to the above configuration and may have any configuration.

For example, in place of the plates 138, 142 and the belt 150, a plate made of metal or resin or other type of supporting board may be accommodated in the cover 132. The supporting board may be provided with the insertion hole 144 at its leading end portion to function as the leading end portion-side plate 142. Note that a base end portion of the supporting board may be shaped to have the same functions as the base end portion-side plate 138 which is a part of the rotation mechanism 130. In this manner, the configuration of the reacher 118 can be more simplified, preventing the webbing 110 from being twisted by the reacher 118 as described above.

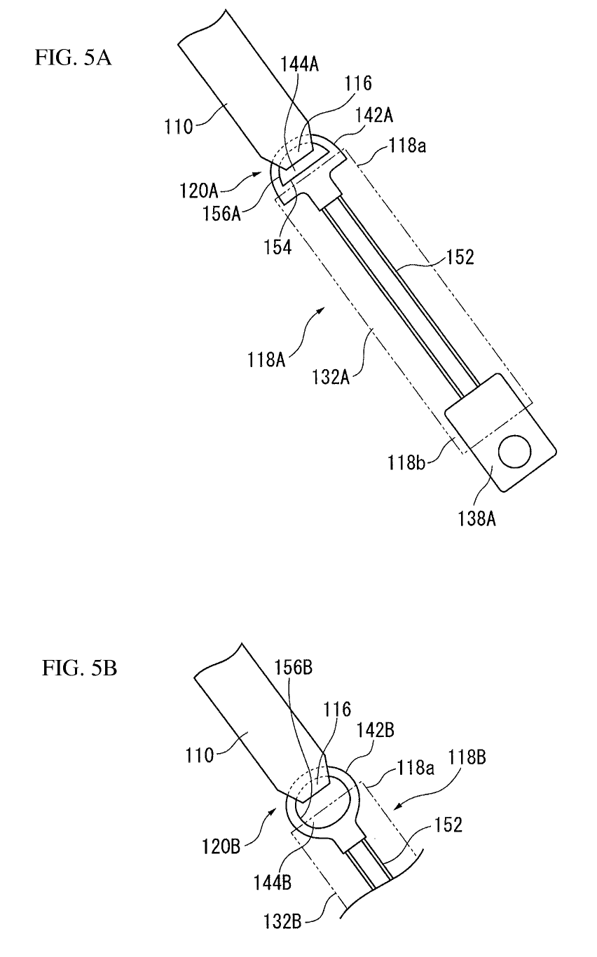

FIGS. 5A and 5B are diagrams illustrating a second embodiment of the present invention. As shown in FIG. 5A, a reacher 118A has a leading end portion-side plate 142A which is a rotation supporter 120A, a base end portion-side plate 138A which is a part of the rotation mechanism 130, and a wire 152 accommodated in a cover 132A. The wire 152 couples the rotation supporter 120A, which is located at the leading end portion 118a of the reacher 118A and the base end portion-side plate 138A, which is located at the base end portion 118b of the reacher 118A.

The rotation supporter 120A has an insertion hole 144A formed in the leading end portion-side plate 142A. The insertion hole 144A is, for example, in a semicircular shape and includes an arc portion 156A extending continuously from a straight line portion 154.

In the reacher 118A of this configuration, the end 116 of the webbing 110 is inserted into the insertion hole 144A having the arc portion 156A. Accordingly, the end 116 of the webbing 110 can reliably be rotated in the vehicle longitudinal direction with respect to the reacher 118A while sliding in contact with the arc portion 156A of the insertion hole 144A along the arc portion 156A. Therefore, such a configuration of the reacher 118A can prevent the webbing 110 from being twisted by the reacher 118A, as occurs in FIG. 4.

The base end portion 118b of the reacher 118A is coupled to the rotation supporter 120A by the wire 152. In such a configuration, when the webbing 110 is pulled inward of the vehicle as the occupant 140 wears the webbing, the wire 152 is bent inward of the vehicle. In this configuration of the reacher 118A, therefore, the rotation supporter 120A can reliably be moved toward the inside of the vehicle in such a manner as to follow the motion of the webbing 110.

FIG. 5B is a diagram showing a modification of the reacher 118A shown in FIG. SA. A reacher 118B is different from the reacher 118A in having a rotation supporter 120B configured by a leading end portion-side plate 142B, in place of the rotation supporter 120A, as shown in FIG. 5B.

The rotation supporter 120B has an insertion hole 144B formed in the leading end portion-side plate 142B. The insertion hole 144B is, for example, in a circular shape having an arc portion 156B. The rotation supporter 120B is coupled to the base end portion-side plate 138A by the wire 152 accommodated in the cover 132B.

The end 116 of the webbing 110 can reliably be rotated in the vehicle longitudinal direction with respect to the reacher 118B while sliding in contact with the arc portion 156B of the insertion hole 144B, in such a manner as to follow a tilting motion of the reacher 118B in the vehicle longitudinal direction. Such a configuration of the reacher 118B can prevent the webbing 110 from being twisted by the reacher 118B, as occurs in FIG. 4.

In this reacher 118B, the rotation supporter 120B is also coupled to the wire 152. Therefore, as with the reacher 118A, when the webbing 110 is pulled inward of the vehicle as the occupant 140 wears the webbing 110, the rotation supporter 120B can reliably be moved toward the inside of the vehicle in such a manner as to follow this motion of the webbing 110.

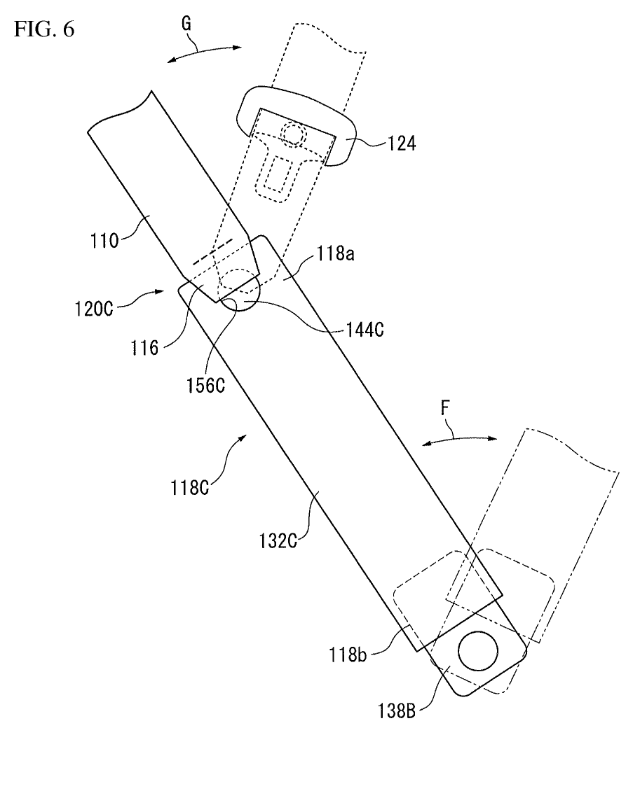

FIG. 6 is a diagram illustrating a third embodiment of the present invention. A reacher 118C is different from those of the embodiments described above in that an insertion hole 144C, into which the end 116 of the webbing 110 is inserted, is formed directly at the leading end portion 118a to configure a rotation supporter 120C.

The reacher 118C has a base end portion-side plate 138B configuring a part of the rotation mechanism 130. The base end portion-side plate 138B is located at the base end portion 118b of the reacher 118C and is partially accommodated and fixed in a cover 132C, as shown in FIG. 6. Further, the insertion hole 144C of the rotation supporter 120C is, for example, in a circular shape and includes an arc portion 156C.

This reacher 118C has a simple configuration in which the insertion hole 144C is directly formed in the leading end portion 118a of the reacher 118C, allowing the end 116 of the webbing 110 to slide in contact with the arc portion 156C of the insertion hole 144C in such a manner as to follow a tilting motion of the reacher 118C in the vehicle longitudinal direction (see an arrow F). In addition, the end 116 of the webbing 110 can be rotated in the vehicle longitudinal direction with respect to the reacher 118C, as shown by an arrow G. Such a configuration of the reacher 118C, therefore, can prevent the webbing 110 from being twisted by the reacher 118C.

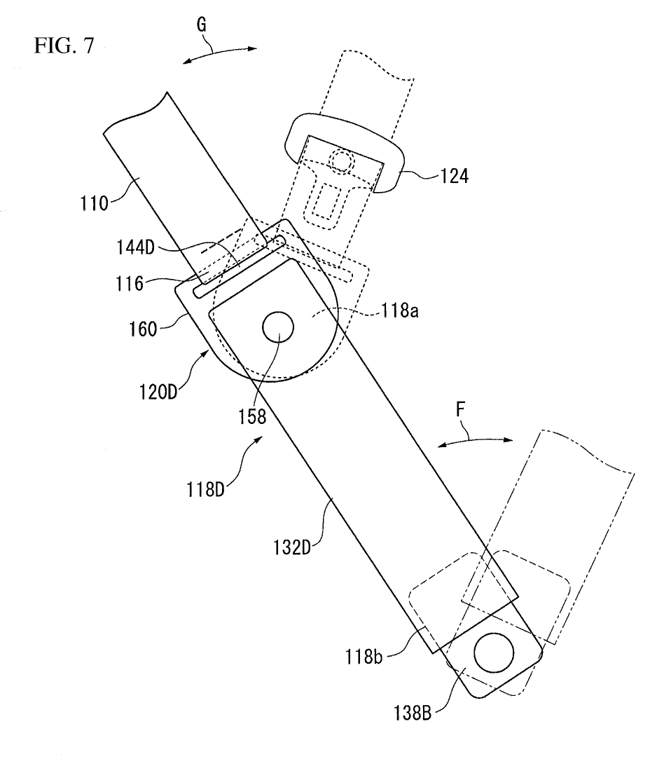

FIG. 7 is a diagram illustrating a fourth embodiment of the present invention. A reacher 118D is different from the reacher 118C in having a rotation supporter 120D in place of the rotation supporter 120C.

The rotation supporter 120D includes a rotating shaft 158 and rotating member 160 provided in the leading end portion 118a of the reacher 118D. The rotating member 160 is, for example, a pulley and rotates in the vehicle longitudinal direction about the rotating shaft 158. The rotating member 160 is partially accommodated in a cover 132D. An insertion hole 144D, that is thin and long in the width direction of the webbing 110, is formed in the rotating member 160. The end 116 of the webbing 110 is inserted into the insertion hole 144D, as shown in FIG. 7, folded back over itself and a portion of the rotating portion 160, and then secured by sewing.

Owing to such a configuration of the reacher 118D, the rotating member 160 can be rotated in the vehicle longitudinal direction with respect to the reacher 118D in such a manner as to follow a tilting motion of the reacher 118D in the vehicle longitudinal direction (see arrow F). Furthermore, the end 116 of the webbing 110 is inserted into the thin, long insertion hole 144D. Therefore, the end 116 of the webbing 110 can be rotated in the vehicle longitudinal direction with respect to the reacher 118D as the rotating member 160 rotates, as shown by the arrow G, without being shifted with respect to the insertion hole 144D. Such a configuration of the reacher 118D can reliably prevent the webbing 110 from being twisted by the reacher 118D.

The above has described preferred embodiments of the present invention with reference to the accompanying drawings; however, obviously the present invention is not limited thereto. It is obvious that a person skilled in the art could devise various changes and modifications within the scope as set forth in the claims, and it is to be understood that these changes and modifications belong, as a matter of course, to the technical scope of the present invention.

The embodiments have described an example in which the seat belt device according to the present invention is applied to an automobile, but the same effects can be achieved even when the seat belt device according to the present invention is applied to an airplane, a vessel and the like.

The present invention can be used in a seat belt device for restraining and protecting an occupant of a vehicle.

I/we claim:

1. A seatbelt device for a vehicle, comprising:
a seatbelt having a first end and a second end;
a tongue plate slideably positioned on the seatbelt between the first and second ends of the seatbelt;
a retractor connected to the first end of the seatbelt;
a belt position changing member connected to the second end of the seatbelt, the belt position changing member being movable between a forward position relative to the vehicle and a rearward position relative to the vehicle;
the second end of the seatbelt being connected to the belt position changing member such that the position of the second end of the seatbelt changes relative to the belt position changing member as the belt position changing member is moved from the rearward position to the forward position.

2. The seatbelt device according to claim 1, wherein the belt position changing member includes a distal end and a proximal end, the distal end being movable between and defining the forward and rearward positions of the belt position changing member, the second end of the seatbelt being connected to the belt position changing member at the distal end.

3. The seatbelt device according to claim 1, wherein the belt position changing member includes a loop member defining an aperture and moving between the rearward and forward positions of the belt position changing member, the second end of the seatbelt being connected to the belt position changing member around the loop member and through the aperture.

4. The seatbelt device according to claim 3, wherein the aperture is in the shape of one of a circle, a semi-circle and an elongated slot.

5. The seatbelt device according to claim 3, wherein the loop member is arcuate in shape.

6. The seatbelt device according to claim 5, wherein the second end of the seatbelt is slidable along the loop member during changing of its position relative to the belt position changing member.

7. The seatbelt device according to claim 1, wherein the belt position changing member includes a proximal end and a distal end, the proximal end being rotatably connected to a structure of the vehicle for rotation about a shaft, the distal end being rotatable about the shaft and defining the rearward and forward positions of the belt position changing member.

8. The seatbelt device according to claim 1, wherein the belt position changing member includes a proximal end attached to a structure of the vehicle and a distal end to which the second end of the seatbelt is directly attached, the proximal end and the distal end being connected to each other by a belt.

9. The seatbelt device according to claim 1, wherein the belt position changing member includes a proximal end attached to a structure of the vehicle and a distal end to which the second end of the seatbelt is directly attached, the proximal end and the distal end being connected to each other by a wire.

10. The seatbelt device according to claim 1, wherein the belt position changing member includes a proximal end attached to a structure of the vehicle and a distal end to which the second end of the seatbelt is directly attached, the proximal end being unitarily formed with the distal end in a one-piece construction.

11. The seatbelt device according to claim 1, wherein the belt position changing member includes a proximal end attached to a structure of the vehicle and a distal end to which the second end of the seatbelt is directly attached, the distal end being directly attached to the proximal end.

12. The seatbelt device according to claim 1, wherein the belt position changing member includes a proximal end attached to a structure of the vehicle and a distal end to which the second end of the seatbelt is attached, the second end of the seatbelt being attached to the distal end for relative rotation therebetween.

13. An seatbelt device for a vehicle, comprising:
a seatbelt having a first end and a second end;
a tongue plate slideably positioned on the seatbelt between the first and second ends of the seatbelt;
a retractor connected to the first end of the seatbelt;
a belt position changing member connected to the second end of the seatbelt, the belt position changing member being movable between a forward position relative to the vehicle and a rearward position relative to the vehicle;
the second end of the seatbelt being connected to the belt position changing member in a first connection position relative to the belt position changing member when the belt position changing member is in the rearward position, the second end of the seatbelt being connected to the belt position changing member in a second connection position relative to the belt position changing member when the belt position changing member is in the forward position.

14. The seatbelt device of claim 13, wherein the second connection position is located on the belt position changing member rearward of the first connection position.

15. The seatbelt device of claim 13, wherein the seatbelt extends obliquely from the belt position changing member when the belt position changing member is in the forward position.

16. The seatbelt device of claim 13, wherein the seatbelt extends axially from the belt position changing member when the belt position changing member is in the rearward position.

17. The occupant connection system of claim 13, wherein the belt position changing member is bendable in a transverse direction to a direction of movement between the rearward position and the forward position by the belt position changing member.

18. The occupant connection system of claim 13, wherein the belt position changing member is bendable in a transverse direction to the front-rear direction of the vehicle.

19. The occupant connection system of claim 13, wherein the first position connection is defined forward of the second position connection relative to the belt position changing member.

20. The occupant connection system of claim 13, wherein the belt position changing member is biased toward the rearward position by the retractor and is biased toward the forward position by a rotation mechanism that is coupled to a proximal end of the belt position changing member, the distal end of the belt position changing member located opposite of the proximal end and being attached to the second end of the seatbelt.
